(19) United States
(12) Patent Application Publication
(10) Pub. No.: US 2016/0286954 A1
(43) Pub. Date: Oct. 6, 2016

(54) FLAP SUPPORT STRUCTURE

(71) Applicants: Da-Chung Wu, Taipei City (TW); Terrence-Louis Chuang, Taipei City (TW)

(72) Inventors: Da-Chung Wu, Taipei City (TW); Terrence-Louis Chuang, Taipei City (TW)

(21) Appl. No.: 14/676,044

(22) Filed: Apr. 1, 2015

(51) Int. Cl. A47B 23/04; G06F 1/16

(52) U.S. Cl. CPC A47B 23/044; G06F 1/1626; G06F 1/1633

(57) ABSTRACT

The invention relates to a flap support structure applied to a tablet device and comprising a first plate body and a second plate body having left and right sides pivotally connected to each other. The first plate body has a first left fold line and a first right fold line sequentially dividing it into a left supporting plate, a baseplate and a right supporting plate. The second plate body has a second left fold line and a second right fold line sequentially dividing it into a left folding plate, a carrying-plate and a right folding plate. Inwardly folding the left supporting plate, the left folding plate, the right supporting plate and the right folding plate forms a three-dimensional support seat having a firm structure for supporting the tablet device.

### BACKGROUND OF THE INVENTION

(1) Field of the Invention

The invention relates to a support structure for a tablet device, and more particularly to a flap support structure capable of forming a three-dimensional support seat by folding a plate body.

(2) Description of the Prior Art

With the increasingly fierce competition in the relevant products, most of the frequently seen handheld electronic devices have the miniaturized features. In order to facilitate the watching and operating, the display screen of the tablet device (e.g., tablet computer, smart mobile phone) having the flat panel display screen (or touch screen) tends to become larger and larger. Consequently, the display screen inevitably occupies the extremely large portion of the surface area of the tablet device. In addition, when being used or browsed, a corresponding support structure is usually utilized to make the tablet device stand slantingly on the desktop to decrease the loading of holding the tablet device for a long time, and to enhance the convenience.

Each of most of the conventional support structures is combined with a protective shell, wherein the cover plate or attached retracting structure of the protective shell is folded to the backside to form the support. In each of these structures, however, one of the sides of the tablet device serves as the fulcrum, and the backside support structure is used to make the tablet device stand slantingly. Although the slantingly standing effect can be obtained, no positioning effect relative to the desktop is formed, and the slip problem upon operation tends to occur. In addition, one side of the tablet device needs to be attached to the desktop. When being used in conjunction with other objects (e.g., a keyboard), the height requirement cannot be satisfied. In addition, when the environment is relatively dirty (desktop dust or other filth) or the placement location with the higher security risk (e.g., many beverage containers are placed on the desktop) is encountered, the tablet device tends to be contaminated by the filth and tends to be damaged. In view of the above-mentioned drawbacks of the conventional support structure of the tablet device, the present inventor has paid attention to the research and development for improving the drawbacks, and thus developed this invention.

### SUMMARY OF THE INVENTION

A main object of the invention is to provide a flap support structure, which can form a three-dimensional support seat for supporting a tablet device by folding the flap to achieve the firm supporting effect.

Another object of the invention is to provide a flap support structure for supporting a tablet device tilted at a proper height and assisting the user in operating, reading or using in conjunction with peripheral objects.

Still another object of the invention is to provide a flap support structure, which has the simple overall structure and the low cost, can be combined with the backside of the protective shell, does not occupy the space after being retracted, or can function as a storage kit for storing the tablet device, and has the wide applicability.

To achieve the above-identified effects, the flap support structure of the invention is applied to a tablet device. The mainly adopted technological means comprises a first plate body and a second plate body. The first plate body has a first left side, a first right side opposite to the first left side, and a first left fold line and a first right fold line disposed between the first left side and the first right side. The second plate body corresponds to the first plate body and has a second left side and a second right side opposite to the second left side. A second left fold line and a second right fold line are disposed between the second left side and the second right side. The first plate body comprises a baseplate, a left supporting plate and a right supporting plate. The baseplate is defined between the first left fold line and the first right fold line. The left supporting plate is defined between the first left side and the first left fold line, and pivotally connected to the baseplate by the first left fold line. The right supporting plate is defined between the first right side and the first right fold line, and pivotally connected to the baseplate by the first right fold line. The second plate body comprises a carrying-plate, a left folding plate and a right folding plate. The carrying-plate is disposed between the second left fold line and the second right fold line and for carrying the tablet device. The left folding plate is disposed between the second left side and the second left fold line and pivotally connected to the carrying-plate by the second left fold line. The right folding plate is disposed between the second right side and the second right fold line and pivotally connected to the carrying-plate by the second right fold line. In addition, the second left side and the first left side are connected together to form a left fold line, so that the left supporting plate and the left folding plate are pivotally connected together by the left fold line, and the second right side and the first right side are connected together to form a right fold line, so that the right supporting plate and the right folding plate are pivotally connected together by the right fold line. When the left supporting plate, the left folding plate, the right supporting plate and the right folding plate are inwardly folded to rest against one another, a three-dimensional support seat for supporting the tablet device is constituted.

According to the above-mentioned structure, the first left fold line and the first right fold line both of the first plate body are symmetrical, and the second left fold line and the second right fold line both of the second plate body may be symmetrical.

According to the above-mentioned structure, the left supporting plate, the left folding plate, the right supporting plate and the right folding plate may be trapezoidal.

According to the above-mentioned structure, the baseplate and the carrying-plate may be trapezoidal or triangular.

According to the above-mentioned structure, a back shell for accommodating the tablet device is combined with the carrying-plate.

According to the above-mentioned structure, the carrying-plate further has at least one slip-resistant strip.

According to the above-mentioned structure, a chamber for storing the tablet device is formed between the first plate body and the second plate body, and openings are formed at front and rear sides of the chamber.

According to the above-mentioned structure, a connector and a fastening assembly may be disposed at the openings at the front and rear sides of the chamber to close the openings, respectively.

According to the above-mentioned structure, the connector may be a zipper.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a decomposed schematic view showing a first plate body and a second plate body according to an embodiment of the invention.

FIG. 2 is a pictorial view showing the embodiment of the invention when being inwardly folded.

FIG. 3 is a pictorial view showing a three-dimensional support seat after the embodiment of the invention is folded.

FIG. 4 is a pictorial view of FIG. 3 at another viewing angle.

FIG. 5 is a schematic view showing a used state of the embodiment of the invention.

FIG. 6 is a schematic view showing a retracted state when the embodiment of the invention is combined with a back shell.

FIG. 7 is a schematic view showing a support state when the embodiment of the invention is combined with a back shell.

FIG. 8 is a schematic view when the embodiment of the invention is applied to the storage application.

FIG. 9 is a decomposed schematic view of FIG. 8.

FIG. 10 is a schematic view showing a support state after FIG. 8 is folded.

### DETAILED DESCRIPTION OF THE PREFERRED EMBODIMENTS

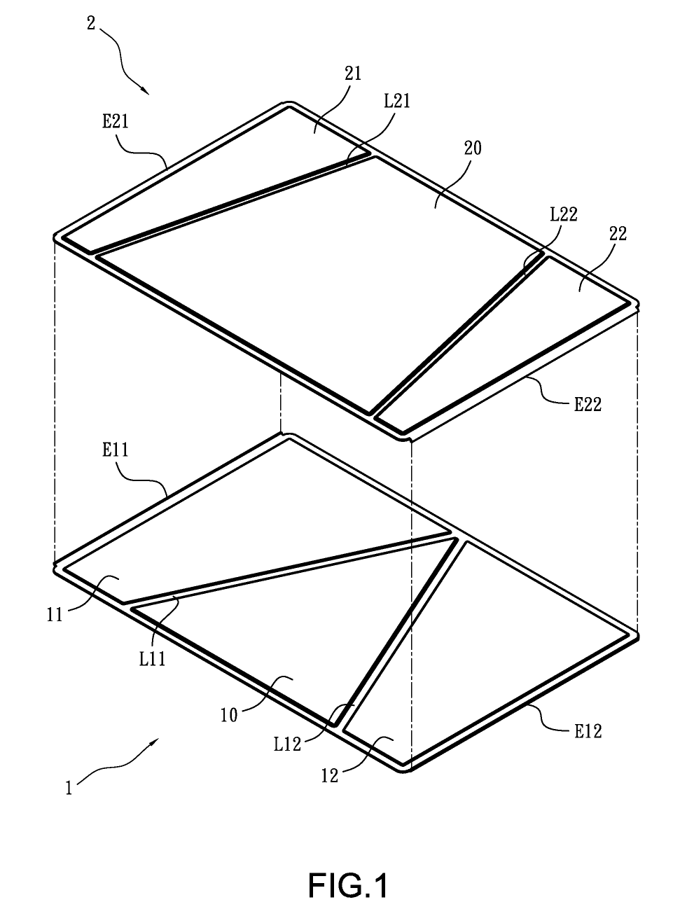

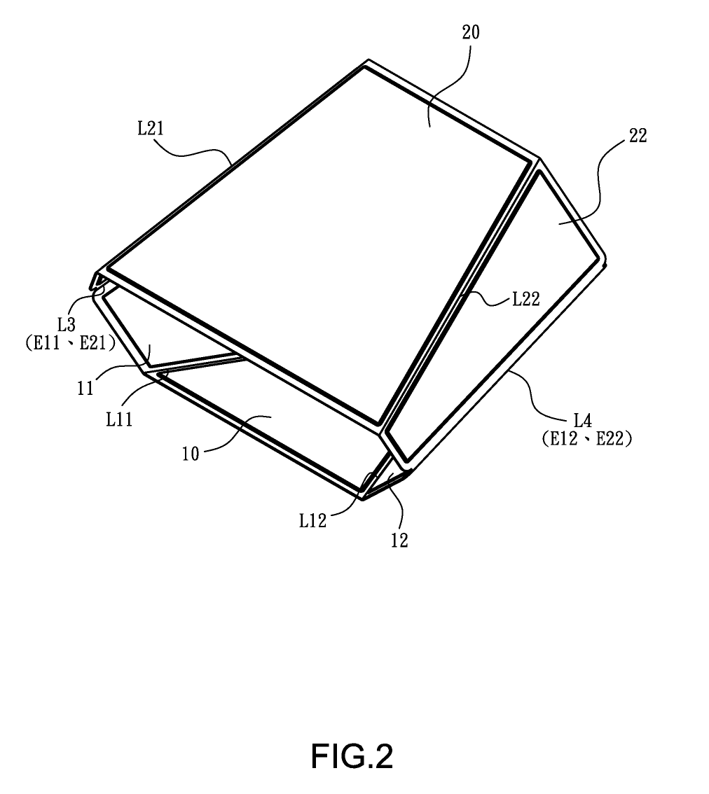

Referring to FIGS. 1 and 2, the flap support structure of the embodiment of the invention mainly comprises a first plate body 1 and a second plate body 2 connected together. The first plate body 1 has a first left side E11 and a first right side E12 opposite to the first left side E11. The second plate body 2 corresponds to the first plate body 1, and similarly has a second left side E21 and a second right side E22 opposite to the second left side E21. The first left side E11 and the second left side E21 are connected together to form a left fold line L3. The first right side E12 and the second right side E22 are connected together to form a right fold line L4. Thus, a plate body structure with heads connected to tails are constructed.

Also, the first plate body 1 has a first left fold line L11 and a first right fold line L12, which are symmetrical and inclined and formed between the first left side E11 and the first right side E12, so that the first plate body 1 is divided into a baseplate 10, a left supporting plate 11 and a right supporting plate 12, which are pivotally rotatable relatively to one another. The baseplate 10 is defined between the first left fold line L11 and the first right fold line L12. The left supporting plate 11 is defined between the first left side E11 and the first left fold line L11 and pivotally connected to the baseplate 10 by the first left fold line L11. The right supporting plate 12 is defined between the first right side E12 and the first right fold line L12, and pivotally connected to the baseplate 10 by the first right fold line L12.

The second plate body 2 has a second left fold line L21 and a second right fold line L22, which are symmetrical and inclined and disposed between the second left side E21 and the second right side E22, so that the second plate body 2 is divided into a carrying-plate 20, a left folding plate 21 and a right folding plate 22, which are pivotally rotatable relatively to each other. The carrying-plate 20 is disposed between the second left fold line L21 and the second right fold line L22. The left folding plate 21 is disposed between the second left side E21 and the second left fold line L21, and is pivotally connected to the carrying-plate 20 by the second left fold line L21. The right folding plate 22 is disposed between the second right side E22 and the second right fold line L22, and is pivotally connected to the carrying-plate 20 by the second right fold line L22.

In addition, by the left fold line L3 and the right fold line L4 for connecting the first plate body 1 and the second plate body 2 together, the left supporting plate 11 and the left folding plate 21 can be pivotally rotated relatively to each other through the left fold line L3, and the right supporting plate 12 and the right folding plate 22 can be pivotally rotated relatively to each other through the right fold line L4.

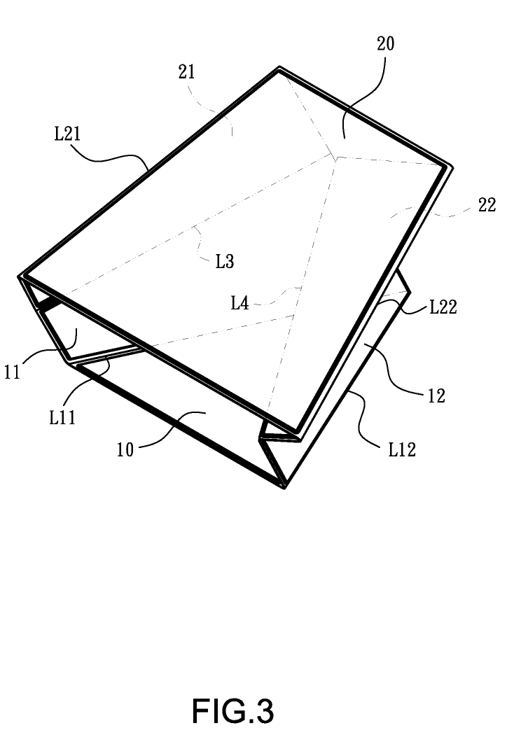

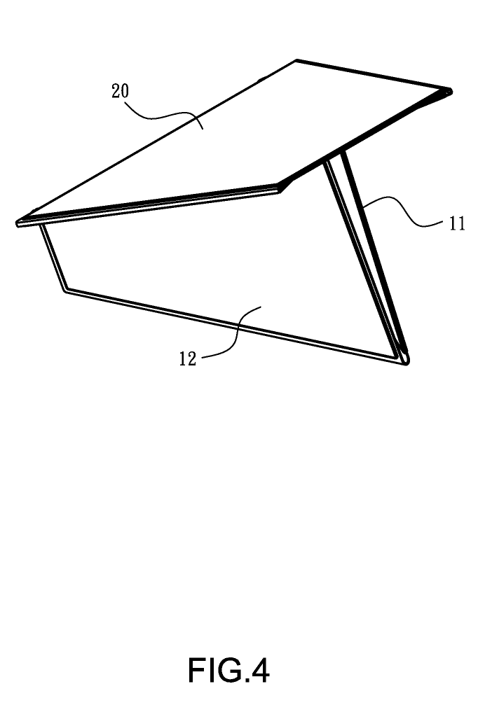

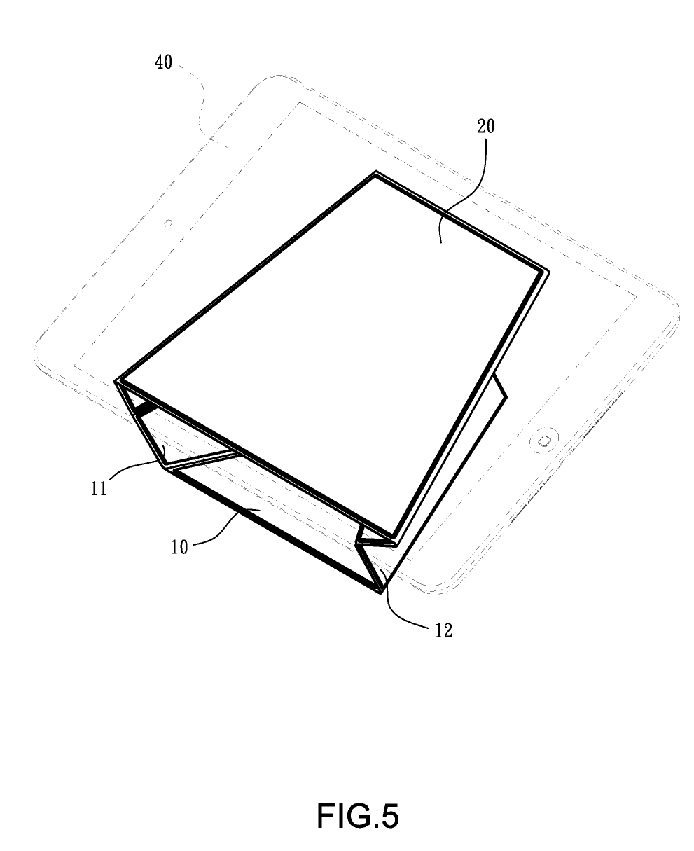

Referring to FIGS. 3 to 5, when being used, it is only necessary to fold the left supporting plate 11 and the left folding plate 21, as well as the right supporting plate 12 and the right folding plate 22 toward the inside of the first plate body 1 and the inside of the second plate body 2 (see FIG. 2), and pivotally rotate them to the resting state (the left folding plate 21 and the right folding plate 22 rest against the inner surface of the carrying-plate 20, as shown in FIGS. 3 and 4). Thus, the three-dimensional support structure the same as a support seat can be obtained to support a tablet device 40, as shown in FIG. 5.

In a feasible embodiment, the baseplate 10 and the carrying-plate 20 can rest against a plane and carry the tablet device 40, respectively, or can carry the tablet device 40 and rest against a plane, respectively, according to the requirements. In this embodiment, the carrying-plate 20 carries the tablet device 40.

In addition, in feasible embodiments, the slopes of the first left fold line L11, the first right fold line L12, the second left fold line L21 and the second right fold line L22 can be designed according to the requirements. When the slope of each fold line is much more inclined inwardly toward the inside, the relative inclination angle between the baseplate 10 and the carrying-plate 20 in the support structure constituted after folding gets larger. That is, when the first left fold line L11, the first right fold line L12, the second left fold line L21 and the second right fold line L22 get much more inclined, the length differences between the parallel long and short sides of the divided trapezoidal left supporting plate 11, right supporting plate 12, left folding plate 21 and right folding plate 22 get larger. In general, in order to make the folded support structure become firm, the extension lines of the first left fold line L11, the second left fold line L21 and the left fold line L3 substantially intersect at one point, and the extension lines of the first right fold line L12, the second right fold line L22 and the right fold line L4 similarly intersect at another symmetrical point.

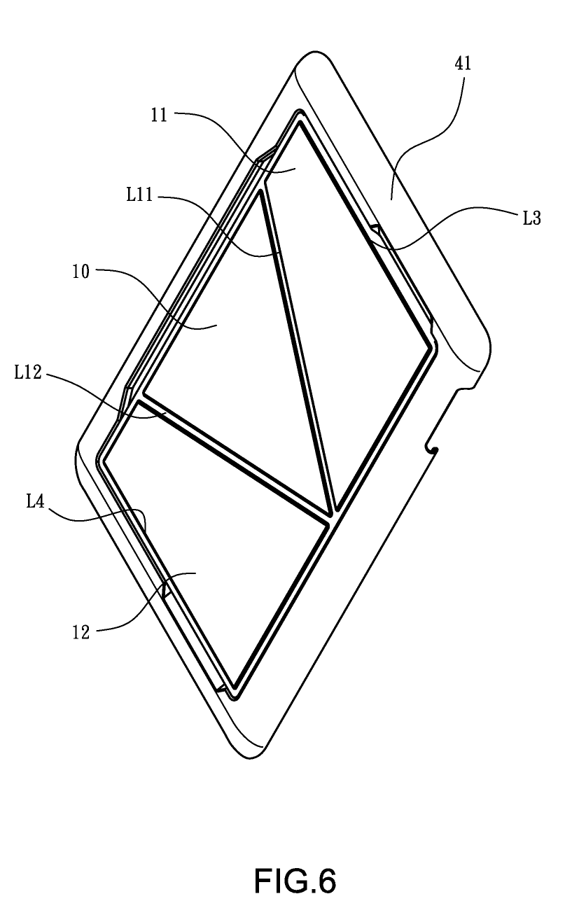

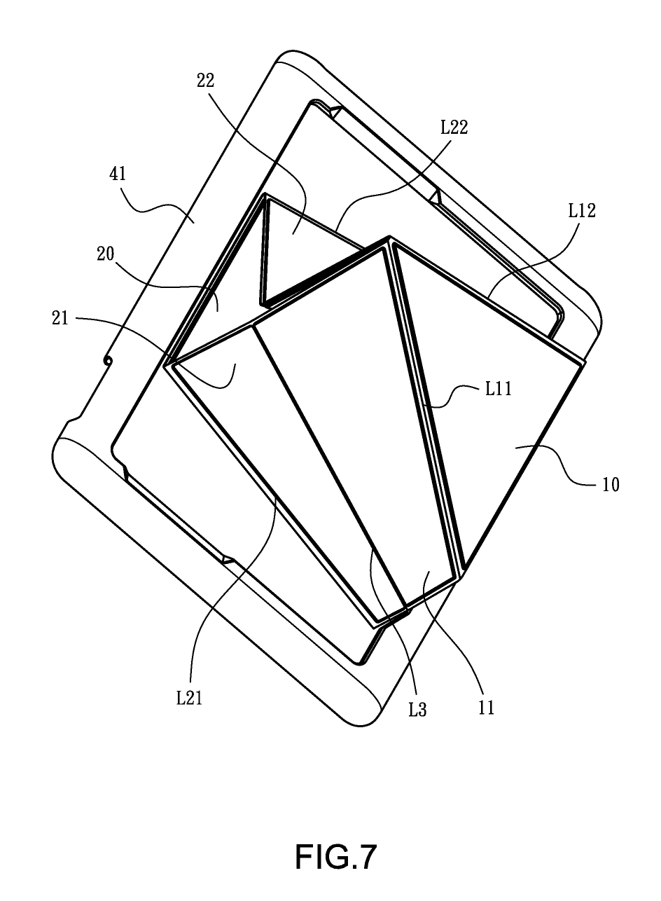

Referring to FIGS. 6 and 7, the above-mentioned flap support structure according to the architecture can be directly applied to a back shell 41 for accommodating the tablet device 40, wherein the backside of the back shell 41 is directly combined with the carrying-plate 20 (or baseplate 10), and the baseplate 10 (or carrying-plate 20) is inclined outwardly by way of folding to constitute the support. As shown in the drawings, a slot is formed on the backside of the back shell 41 to accommodate the retracted first plate body 1 and second plate body 2, and the carrying-plate 20 of the second plate body 2 is fixed into and combined with the slot. When being used, it is only necessary to pull the baseplate 10 out, and then inwardly fold the left supporting plate 11, the left folding plate 21, the right supporting plate 12 and the right folding plate 22 to rest against the predetermined position, so that the three-dimensional support seat can be obtained to support the tablet device 40.

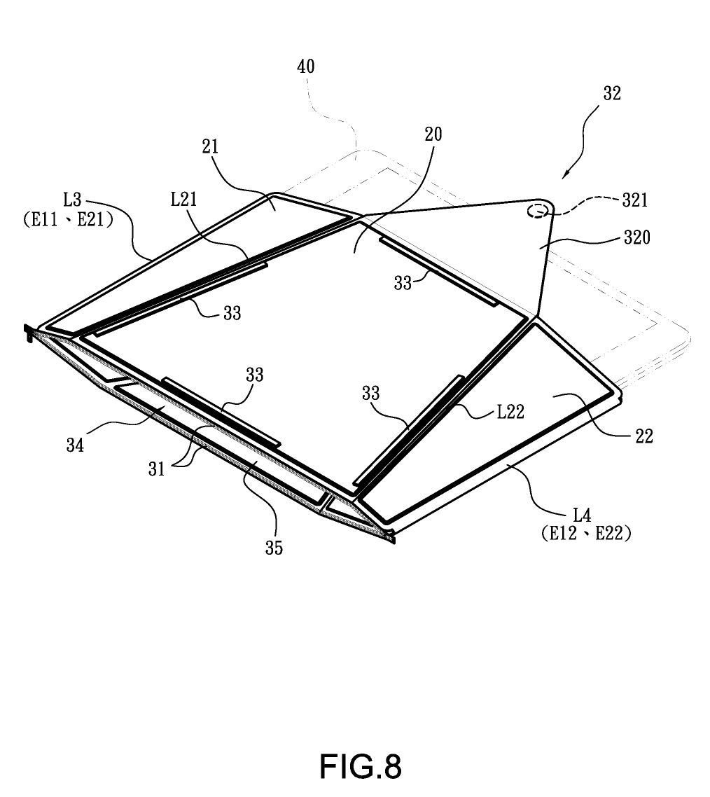

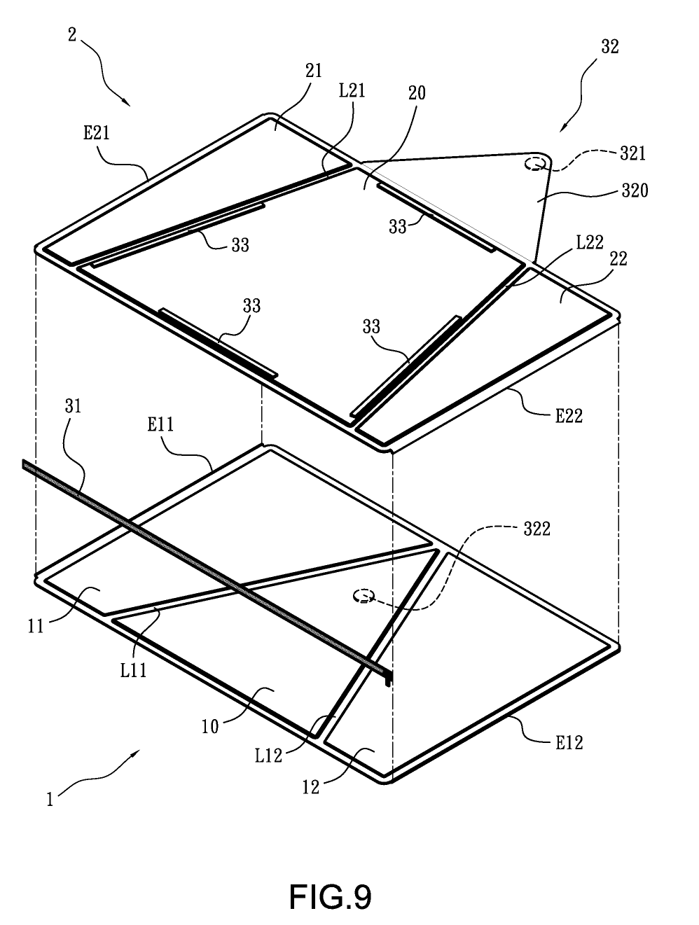

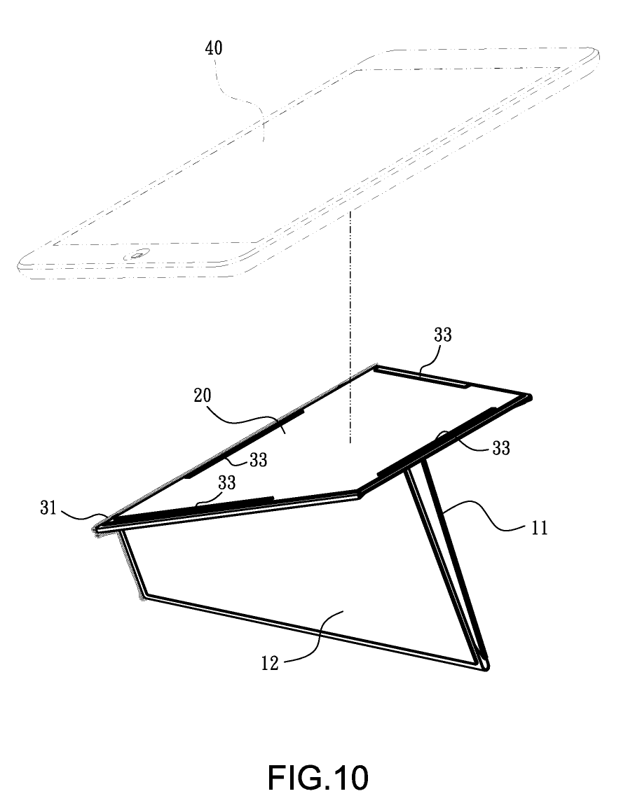

Referring to FIGS. 8 to 10, the architecture using the above-mentioned flap support structure further functions to store the tablet device 40. A gap between the first plate body 1 and the second plate body 2 constitutes a chamber 34 for accommodating the tablet device 40, wherein openings 35 are formed at the front and rear sides of the chamber 34, and a connector 31 and a fastening assembly 32 for controlling opening and closing of the openings 35 are further disposed at the openings 35 at the front and rear sides of the chamber 34, respectively. In this manner, the structure with the supporting and storing functions can be constructed. In this embodiment, a zipper (connector 31) is disposed at the rear opening 35, the zipper is closed or opened to connect the backsides of the first plate body 1 and the second plate body 2 together or separates the backsides of the first plate body 1 and the second plate body 2 from each other, so that the object of closing or opening the backside opening 35 can be achieved. The fastening assembly 32 is disposed at the front side opening and comprises a fastening edge 320 outwardly extended from the carrying-plate 20, a fastening member 321 disposed on the inner side of the fastening edge 320, and a fastened member 322, which is disposed on the baseplate 10 and corresponds to the fastening member 321.

In a feasible embodiment, one side of the carrying-plate 20 for carrying the tablet device 40 may further have a slip-resistant strip 33 for increasing the relative friction and enhancing the convenience of use.

In summary, the invention can indeed achieve the convenient operation effect and the firm supporting effect, can satisfy the novelty and inventive step, and can be widely applied.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

1. A flap support structure applied to a tablet device, the flap support structure comprising:
a first plate body having a first left side, a first right side opposite to the first left side, and a first left fold line and a first right fold line disposed between the first left side and the first right side, wherein the first plate body comprises:
a baseplate defined between the first left fold line and the first right fold line;
a left supporting plate defined between the first left side and the first left fold line, and pivotally connected to the baseplate by the first left fold line; and
a right supporting plate defined between the first right side and the first right fold line, and pivotally connected to the baseplate by the first right fold line; and
a second plate body corresponding to the first plate body and having a second left side, a second right side opposite to the second left side, and a second left fold line and a second right fold line disposed between the second left side and the second right side, wherein the second plate body comprises:
a carrying-plate which is defined between the second left fold line and the second right fold line and for carrying the tablet device;
a left folding plate defined between the second left side and the second left fold line and pivotally connected to the carrying-plate by the second left fold line; and
a right folding plate defined between the second right side and the second right fold line and pivotally connected to the carrying-plate by the second right fold line;
wherein the second left side and the first left side are connected together to form a left fold line, so that the left supporting plate and the left folding plate are pivotally connected together by the left fold line, and the second right side and the first right side are connected together to form a right fold line, so that the right supporting plate and the right folding plate are pivotally connected together by the right fold line; wherein when the left supporting plate, the left folding plate, the right supporting plate and the right folding plate are inwardly folded to rest against one another, a three-dimensional support seat for supporting the tablet device is constituted.

2. The flap support structure according to claim 1, wherein the first left fold line and the first right fold line both of the first plate body are symmetrical, and the second left fold line and the second right fold line both of the second plate body are symmetrical.

3. The flap support structure according to claim 2, wherein the left supporting plate, the left folding plate, the right supporting plate and the right folding plate are trapezoidal.

4. The flap support structure according to claim 2, wherein each of the baseplate and the carrying-plate is trapezoidal or triangular.

5. The flap support structure according to claim 1, wherein a back shell for accommodating the tablet device is combined with the carrying-plate.

6. The flap support structure according to claim 3, wherein a back shell for accommodating the tablet device is combined with the carrying-plate.

7. The flap support structure according to claim 4, wherein a back shell for accommodating the tablet device is combined with the carrying-plate.

8. The flap support structure according to claim 1, wherein the carrying-plate further has at least one slip-resistant strip.

9. The flap support structure according to claim 3, wherein the carrying-plate further has at least one slip-resistant strip.

10. The flap support structure according to claim 4, wherein the carrying-plate further has at least one slip-resistant strip.

11. The flap support structure according to claim 1, wherein a chamber for storing the tablet device is formed between the first plate body and the second plate body, and openings are formed at front and rear sides of the chamber.

12. The flap support structure according to claim 11, wherein a connector and a fastening assembly are disposed at the openings at the front and rear sides of the chamber to close the openings, respectively.

13. The flap support structure according to claim 12, wherein the connector is a zipper.

14. The flap support structure according to claim 3, wherein a chamber for storing the tablet device is formed between the first plate body and the second plate body, and openings are formed at front and rear sides of the chamber.

15. The flap support structure according to claim 14, wherein a connector and a fastening assembly are disposed at the openings at the front and rear sides of the chamber to close the openings, respectively.

16. The flap support structure according to claim 15, wherein the connector is a zipper.

17. The flap support structure according to claim 4, wherein a chamber for storing the tablet device is formed between the first plate body and the second plate body, and openings are formed at front and rear sides of the chamber.

18. The flap support structure according to claim 17, wherein a connector and a fastening assembly are disposed at the openings at the front and rear sides of the chamber to close the openings, respectively.

19. The flap support structure according to claim 18, wherein the connector is a zipper.
